(19) United States
(12) Patent Application Publication
(10) Pub. No.: US 2002/0134571 A1
(43) Pub. Date: Sep. 26, 2002

(54) Elastic electrical contact with axial pressure, comprising adjustable connection terminal

(76) Inventor: Didier Bienvenu, Champigny-sur-Marne (FR)

Correspondence Address: GREENBLUM & BERNSTEIN, P.L.C., 1941 ROLAND CLARKE PLACE, RESTON, VA, 20191, US

(21) Appl. No.: 10/049,614

(22) PCT Filed: Jun. 21, 2001
(86) PCT No.: PCT/FR01/01949

(30) Foreign Application Priority Data
Jun. 22, 2000 (FR) 00/08004

(51) Int. Cl. H02G 3/18

(52) U.S. Cl. 174/65 R

(57) ABSTRACT

The invention concerns an elastic electrical contact with axial pressure, comprising an adjustable connection terminal designed to be housed in a guide shaft (2) open at both ends, provided in an apparatus to be equipped (A), and comprising a mobile contact head (5) connected to a connection terminal (10) of a supply cable (9), by a deformable conductor (5), the contact head (3) being stressed by a coil spring (8) operating by compression which encloses said deformable conductor and which is supported at each of its ends, respectively on the contact head (3) and on a retaining element (4) which is housed in the base of the guide shaft (2) and fixed to the deformable conductor. Said contact is characterised in that the retaining element (4) is a sleeve which is fixed to the deformable conductor (5) and traversed by an extension (5′) of said deformable conductor (6) at the end of which is provided the terminal (10) for connection to the electric supply cable (9), so that said terminal is adjustable owing to the flexibility of the deformable conductor.

The invention relates to an elastic electrical contact with axial pressure comprising an adjustable connection terminal.

Elastic electrical contacts with axial pressure are well known and frequently used to equip electrical outlets or a movable connection plug.

They each have an element, or contact head, which is made to translate over a certain amplitude in a guide shaft which is provided in an insulating part of the apparatus to equip and therefore, must be connected to a connection terminal of a supply cable by a deformable conductor.

The contact head is designed to come into elastic contact, under the action of a coil spring with an antagonistic contact, which may be rigid or elastic, provided in a plug or a connector base. The aforementioned coil spring, which is housed in a guide shaft and operates by compression, encloses the deformable conductor and leans at each of its ends respectively on a bearing surface of the connection terminal and a bearing surface of the contact head.

Known electric contacts of this type use as deformable conductor a metal braid which can be deformed by crushing.

In this type of contact, the supply cable is generally rigid or semi-rigid and connected to the connection terminal. It is often difficult to house it in an apparatus whose shape must obviously be optimised for its function and not for the installation of the cable, especially when the supply cable is rigid and not coaxial with the contact.

That is why the inventor tried to design a contact comprising an adjustable connection terminal.

To this effect, the invention proposes an elastic electric contact with axial pressure designed to be housed in a guide shaft open at both ends, provided in an apparatus to be equipped, and comprising a mobile contact head connected to a connection terminal of a supply cable by a deformable conductor, the contact head being stressed by a coil spring operating by compression which encloses said deformable conductor and is supported at each of its ends respectively on the contact head and a retaining element which is housed in the base of the guide shaft and fixed to the deformable conductor, said contact being characterised in that the retaining element is a sleeve which is fixed to the deformable conductor and traversed by an extension of said deformable conductor at the end of which is provided the terminal for connection to the electric supply cable, so that said terminal is adjustable owing to the flexibility of the deformable conductor,

It is clear that such a device facilitates cabling which, additionally, can be achieved without requiring much space.

Such an arrangement does not cause any additional contact resistance and thus no further heating. The contacts can be prepared and arranged in advance in the apparatus, then connected by means of standard tools,

According to a form of embodiment, the sleeve fixed to the deformable conductor is retained in the guide shaft by at least one washer which leans against the base of the guide shaft or an intermediate piece.

To improve tightness in connecting the supply cable to the guide shaft, the invention provides a particular form of embodiment in which at least one tubular seal is clamped on the base of the guide shaft, traverses said base, and encloses the extension of the deformable conductor and the connection terminal and grips the external sheath of the supply cable. Together with an adjustable connection terminal, this means ensures tightness and electrical isolation between various contacts.

For example, the seal has an annular lip which is provided between the sleeve or a part connected to it, and the base of the guide shaft, in such a manner that an axial pressure of the coil spring is exerted on said lip. In case the sleeve is provided with at last one washer as mentioned above, the lip of the seal is then gripped between said washer and the base of the guide shaft.

To make tightness complete the contact head can also be provided with a toric seal.

As previously mentioned, the deformable conductor, which may be of any type, is usually in the form of a braid which can be deformed by crushing.

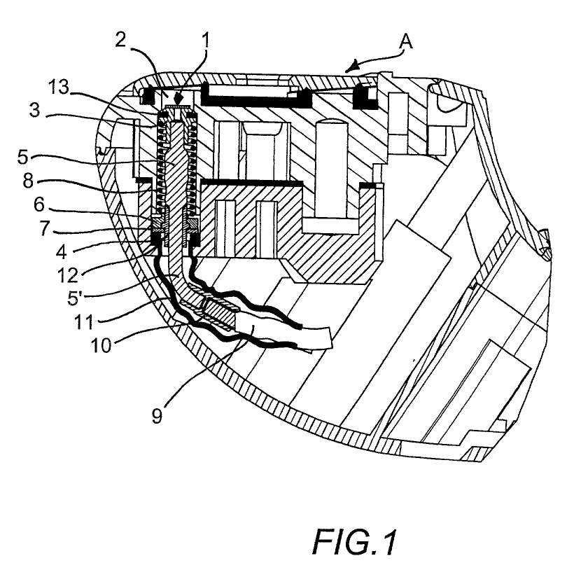

The invention will be more readily understood from the description below and the only [sic] accompanying drawing (FIG. 1) which is a sectional view of a part of a removable hold of a connector provided with at least one contact according to the invention.

The figure shows part of an apparatus to be equipped A, which in this case, is a removable hold of a connector provided with at least one contact according to the invention.

The removable hold shown is obviously given as an example and it can be an electrical outlet.

The contact 1 is provided in an insulating place or guide shaft 2, also called contact support, provided in the apparatus A, said guide shaft being open at both ends.

The contact 1 has a contact head 3 which is movably and longitudinally mounted in the guide shaft 2. As shown in the drawings [sic], the contact head is retained in the guide shaft 2 by a choke in the latter and electrically connected to a retaining element 4 (FIG. 1), 4′ (FIG. 2) provided in the base of the guide shaft 2 by a deformable conductive braid 5 which can be deformed by crushing.

The retaining element has also two washers 6, 7, the upper washer 6 being slit for mounting and production.

A coil spring 8 operating by compression is placed around the braid 5 between a bearing surface of the contact head 3 and the upper washer 6 of the retaining element 4.

In that way, it can be seen that the spring 8 retains the contact head 3 in the position shown, namely towards the orifice corresponding to the guide shaft 2, said contact head being provided as mentioned earlier to come into elastic contact with an antagonistic contact (not shown) under the action of the spring 8.

Such a contact is naturally designed to be connected to an electrical supply cable placed in the apparatus such as the cable 9 shown in the figure.

In a known manner the retaining element has a terminal for connection to the cable 9, in the form of embodiment of the invention, to render the terminal adjustable, said retaining element 4 is a sleeve crimped or soldered on the braid 5, and said braid has an extension 5′ which traverses said sleeve 4 and emerges from the guide shaft 2 while the end of the extension 5′ of the braid is provided with a terminal 10 for connection to the cable 9 in such a manner that said terminal 10 is adjustable as the braid is flexible.

The connection terminal is provided with any suitable means to ensure connection, such as a clamping screw, unless connection is achieved by crimping or soldering.

In order to seal or isolate the contact terminal and the extension of the braid, the invention provides a flexible tubular seal 11 with a lip 12.

The lip 12 is placed between the lower washer 7 of the retaining element 4 and the base of the guide shaft 2.

The seal 11 partially encloses the retaining element 4 as well as the extension 5′ of the braid 5 and the connection terminal 10, and grips the externa sheath of the supply cable 9.

Naturally the lip 12 of the seal 11 is compressed by the action of the spring and thus assures aimed tightness.

To complete tightness the contact head 3 has also a toric seal 13 as shown in the drawings.

The seal 11 consists, for example, of a single piece of rubber which can advantageously be curled up to facilitate connection, but is may also have several parts of different types.

Tightness between the insulating material in which the guide shaft is provided and the external sheath of the cable 9 is thus achieved.

As mentioned earlier, the seal ensures not only tightness, but also electrical insulation from adjacent contacts.

1. An elastic electrical contact with axial pressure comprising an adjustable connection terminal, designed to be housed in a guide shaft (2) open at both ends, provided in an apparatus to be equipped (A), and comprising a mobile contact head (5) connected to a connection terminal (10) of a supply cable (9), by a deformable conductor (5), the contact head (3) being stressed by a coil spring (8) operating by compression which encloses said deformable conductor and which is supported at each of its ends respectively on the contact head (3) and on a retaining element (4) which is housed in the base of the guide shaft (2) and fixed to the deformable conductor, characterised in that the retaining element (4) is a sleeve which is fixed to the deformable conductor (5) and traversed by an extension (5′ ) of said deformable conductor (6) at the end of which is provided the terminal (10) for connection to the electric supply cable (9), so that said terminal is adjustable owing to the flexibility of the deformable conductor.

2. An electrical contact as claimed in claim 1, characterised in that the sleeve (4) fixed to the deformable conductor is retained in the guide shaft (2) by at least one washer (6, 7) which leans against the base of the guide shaft or an intermediate piece.

3. An electrical contact as claimed in any one of the claims 1 and 2, characterised in that at least one tubular seal (11) is clamped on the base of the guide shaft, traverses said base, and encloses the extension (5′) of the deformable conductor (5) and the connection terminal (10) and grips the external sheath of the supply cable (9).

4. An elastic electrical contact as claimed in claim 3, characterised in that the seal (11) has an annular lip (12) which is provided between the sleeve (4) or a part (6) connected to a, and the base of the guide shaft, in such a manner that an axial pressure of the coil spring (8) is exerted on said lip (12).

5. An electrical contact as claimed in any one of the claims 1 to 4, characterised in that the contact head (3) is also provided with a toric seal (13).

6. An electrical contact as claimed in any one of the claims 1 to 5, characterised in that the deformable conductor (5) is in the form of a braid which can be deformed by crushing.
